(19) United States
(12) Patent Application Publication
(10) Pub. No.: US 2022/0304464 A2
(43) Pub. Date: Sep. 29, 2022

(54) Cushioning Platform for Print Media and Electronic Devices

(71) Applicant: Michael John Disher, Palm Bay, FL (US)

(72) Inventor: Michael John Disher, Palm Bay, FL (US)

(21) Appl. No.: 16/829,169

(22) Filed: Mar. 25, 2020

(51) Int. Cl. A47B 23/06; F16M 13/02

(52) U.S. Cl. CPC A47B 23/06; F16M 13/025; F16M 13/04

(57) ABSTRACT

A cushioning platform to be used when reading print media such as books or looking at a tablet computer or similar electronic device while reclining. The user places the platform between their book or device and their body, on top of any clothing or blanket. The platform distributes the weight of the user's hands and the book or device over a larger area, increasing comfort. The platform also locates the bottom of the book or device above the user's clothes or blanket, helping to prevent the user's clothes or blanket from interfering with page turning, or from obscuring the bottom of the device screen or interfering with use of the home button.

### CROSS REFERENCE TO RELATED APPLICATION

This application claims the benefit of Provisional Patent Application No. 62/825,280 filed Mar. 28, 2019 by the present inventor.

### TECHNICAL FIELD

The present invention pertains to reading and content viewing, and more particularly to a cushioning platform for supporting hand-held print media and electronic devices resting on the body of a user.

### BACKGROUND OF THE INVENTION

Many people read a book or other print media (hereafter “book”) or look at a tablet or laptop computer, e-reader, mobile telephone, or similar electronic device (hereafter “device”) while reclining, for example while relaxing on a sofa, or in bed before falling asleep. The people often lay on their back, hold or support the book or device with their hands, and rest the book or device on their body, for example on their chest or stomach. In this situation, two issues may arise. The combined weight of the person's hands and the book or device is focused on the bottom edge of the book cover and spine, or on the device's narrow edge, potentially causing discomfort, particularly over time.

A second problem may arise if the person rests the book or device on their clothes, a blanket, or a pillow or other soft object. In these instances, the book or device can sink into the person's clothes, blanket, or soft object, and the clothes, blanket or soft object can interfere with page turning, or it can obscure the bottom of the device screen and hamper use of the home button.

Accordingly, there is a need for a cushioning platform (hereafter “platform”) that can be placed between the user's book or device and the user's body and on top of any clothes, blanket or soft object. The platform distributes the weight of the hands and book or device over a larger area, reducing discomfort, and the platform places the bottom of the book or device above the clothes, blanket or soft object and so facilitates page turning, viewing the bottom of the device screen and access to and use of the home button.

### SUMMARY OF THE INVENTION

The present invention is a semi-rigid planar cushioning platform to be used by people who read a book or look at a device while reclining. The user places the platform on their body and on top of any clothes, blanket or soft object, and the book or device rests on the platform. The user maintains the book or device in the desired position with their hands.

The platform is not designed or intended to support a book or device by itself. This allows the user to hold their book or device in any position that is comfortable for them while resting the book or device on the platform. The platform takes the combined weight of the user's hands and their book or device and distributes it over an area that is larger than the bottom edge of their book or device, and so decreases any discomfort associated with that focused weight. The platform is semi-rigid, allowing it to substantially conform to moderately irregular surfaces and so distribute weight over a larger supported area to maximize comfort.

The top surface of the platform has a friction-enhancing property to reduce the likelihood that the bottom edge of the book or device will slip while resting on the platform. The bottom surface also has a friction-enhancing property to help reduce the likelihood that the platform will slip while in use. The bottom surface is also skin-friendly, allowing the user to place the platform on bare skin.

The platform also locates the bottom of the book or device above the user's clothing, blanket or soft object so book pages turn easily, the device screen is not obscured, and the device home button is visible and readily accessible.

The platform's planar top surface allows it to be used with books and devices of varying sizes, including those whose width exceeds that of the platform such that the ends of the book or device overhang the ends of the platform.

The platform is relatively small, thin and lightweight, making it easy to transport and store. The platform will easily fit in most backpacks, messenger and computer bags, handbags, briefcases, totes, and other common means of transporting books and personal devices.

### SUMMARY OF THE EMBODIMENTS

In one aspect of the disclosure, the platform has a semi-rigid planar body comprising a skin-friendly material, the top and bottom surfaces of which possesses friction-enhancing properties.

In another aspect of the disclosure, the platform comprises a semi-rigid top member, the top surface of which possesses friction-enhancing properties. The top member is adhered or otherwise suitably attached to a lower member possessing cushioning properties, the bottom surface of which is skin-friendly and possesses friction-enhancing properties.

In another aspect of the disclosure, the platform has a semi-rigid planar body comprising a top member, the top surface of which possesses friction-enhancing properties, a bottom member, the bottom surface of which is skin-friendly with friction-enhancing properties, and a thin, semi-rigid stiffening insert that is disposed between the top and bottom members. The stiffening insert is adhered or otherwise suitably attached to the top and bottom members, which are further attached together around the periphery by adhesive and/or stitching with thread, or other suitable means.

Other embodiments, in addition to the embodiments enumerated above, will become apparent from the detailed description, taken in conjunction with the accompanying drawings, which illustrate, by way of example, the principles of the platform. By way of example and not limitation, the corners need not be radius shaped. A loop to hold a writing instrument or a device stylus might be added to one edge of the platform. The bottom surface of the platform may be textured or shaped to aid ventilation.

### BRIEF DESCRIPTION OF THE DRAWINGS

FIG. 1 is a top perspective view of an exemplary platform having a semi-rigid planar body comprising a skin-friendly material, the top and bottom surfaces of which possesses friction-enhancing properties.

FIGS. 2A and 2B show perspective views of the top and bottom of an exemplary platform comprising a semi-rigid top member, the top surface of which possesses friction-enhancing properties. This top member is adhered or otherwise suitably attached to a bottom cushioning member, the bottom surface of which is skin-friendly and possesses friction-enhancing properties.

FIG. 3A shows a top perspective view of a platform comprising a top member, a bottom member, and a semi-rigid stiffening insert disposed between the top and bottom members.

FIG. 3B shows a perspective view of the bottom of the platform shown in FIG. 3A.

FIG. 4 shows a top perspective exploded view of the platform of FIGS. 3A and 3B.

FIG. 5 shows a top perspective view of a person in bed and under a blanket using a platform with a tablet computer.

FIG. 6 shows a top perspective view of a person in bed and under a blanket using a platform with a book.

### DETAILED DESCRIPTION OF SPECIFIC EMBODIMENTS

The following description provides numerous specific details for the purpose of illustrating the general principles of the embodiments. The description is not intended to be limiting and should not be construed in a limiting sense.

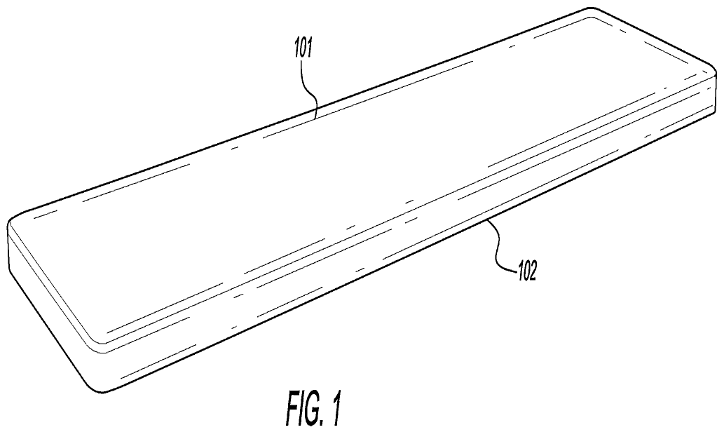

FIG. 1 provides a top perspective view of an exemplary platform comprising a single piece of skin-friendly, semi-rigid material such as ethylene-vinyl acetate (EVA) foam or other material having similar properties with friction-enhancing top 101 and bottom 102 surfaces.

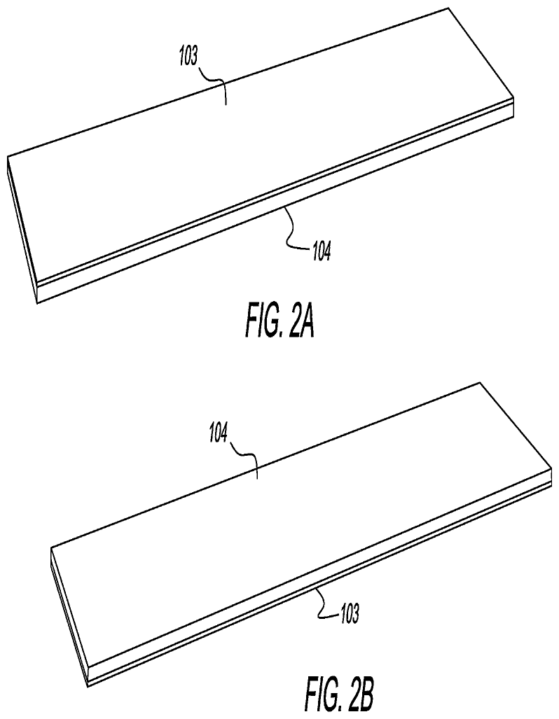

FIGS. 2A and 2B show perspective views of the top and bottom of an exemplary platform comprising a top member 103 composed of plastic sheet material with a friction-enhancing top surface, semi-rigid leather with a buffed or sanded top surface, or other semi-rigid material with similar properties. The top member 103 is adhered or otherwise suitably attached to a bottom member 104 possessing cushioning properties with a skin-friendly bottom surface having friction-enhancing properties. The bottom member 104 can be composed of open or closed cell foam with or without an adhered or otherwise attached covering formed from Lycra® or similar fabric, gel cushioning material with an adhered or otherwise attached covering formed from Lycra® or similar fabric, or other materials having similar properties.

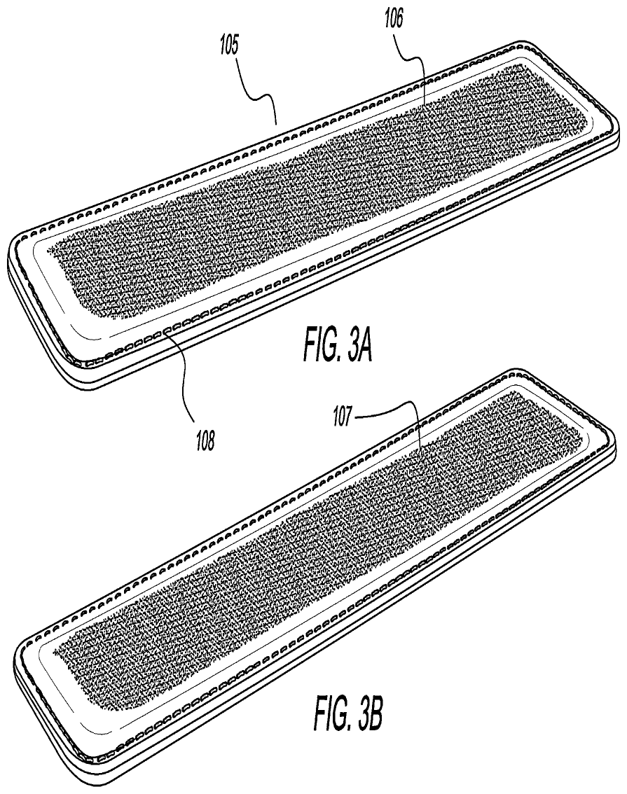

FIGS. 3A and 3B show perspective views of the top and bottom of an exemplary platform 105. This embodiment comprises a top member 106 and a bottom member 107. The top member possesses cushioning properties and has a friction-enhancing top surface. The bottom member possesses cushioning properties and the bottom surface is skin-friendly and friction-enhancing. The top 106 and bottom 107 members can be composed of the same or different materials. In one embodiment, the top and bottom members could be composed of nubuck leather or other materials possessing similar properties. The top member 106 and bottom member 107 are stitched 108 together around the periphery near the edge. The corners of the top 106 and bottom 107 members have a radius shape to facilitate continuous and uniform stitching around said corners.

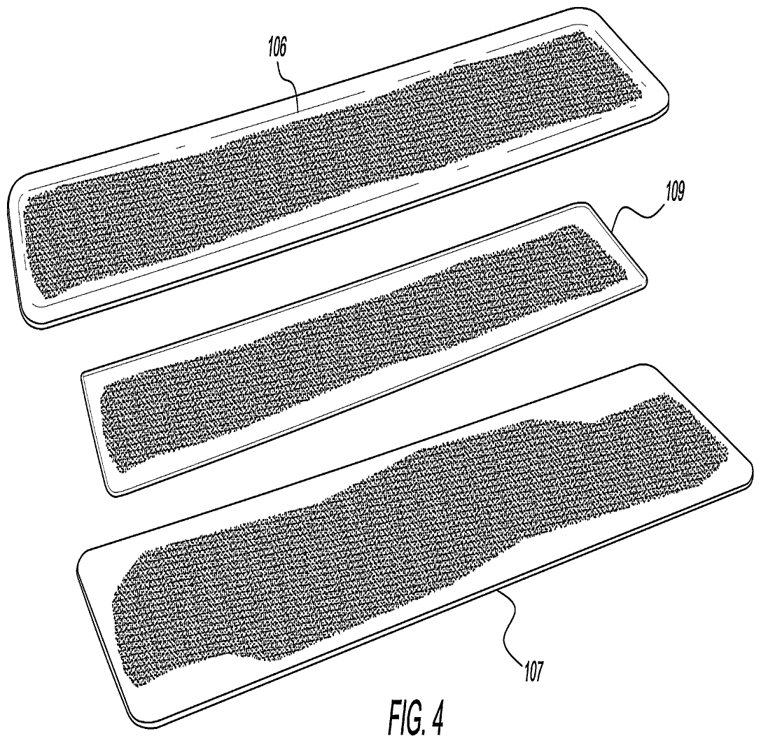

FIG. 4 shows a top perspective exploded view of the exemplary platform 105 shown in FIGS. 3A and 3B. A thin, semi-rigid stiffening insert 109 composed of high-density polyethylene (HDPE) or similar material is disposed between and adhered or otherwise suitably attached to the top member 106 and bottom member 107. The stiffening insert 109 is substantially the same shape as the top 106 and bottom 107 members, having slightly smaller length and width dimensions as well as smaller radius corners to facilitate continuous and uniform stitching 108 around the periphery near the edges of the top 106 and bottom 107 members.

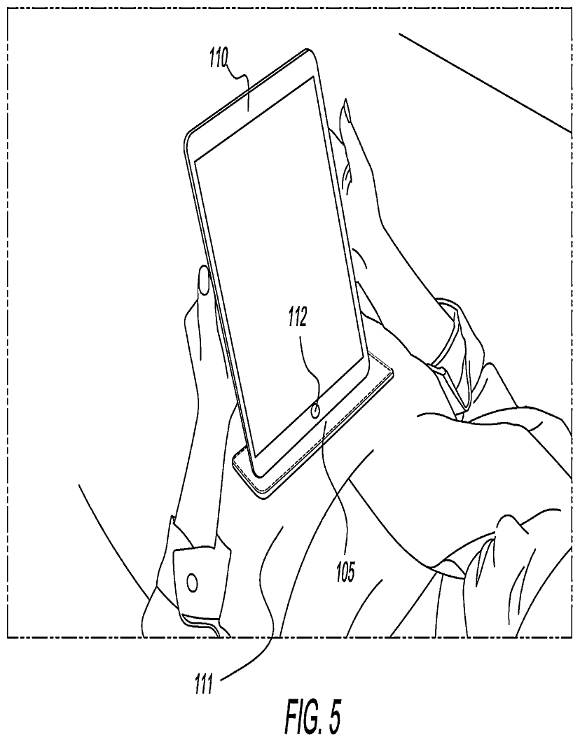

FIG. 5 shows the platform 105 in use with a tablet computer 110. The principles illustrated in FIG. 5 will apply to other similar devices. The platform is placed on top of the user's blanket 111 and under the user's device 110. When used in this manner, the platform distributes the weight of the user's hands and device, reducing discomfort. The platform also locates the bottom edge of the device above the blanket, preventing the blanket from obscuring the bottom of the device screen and the home button 112.

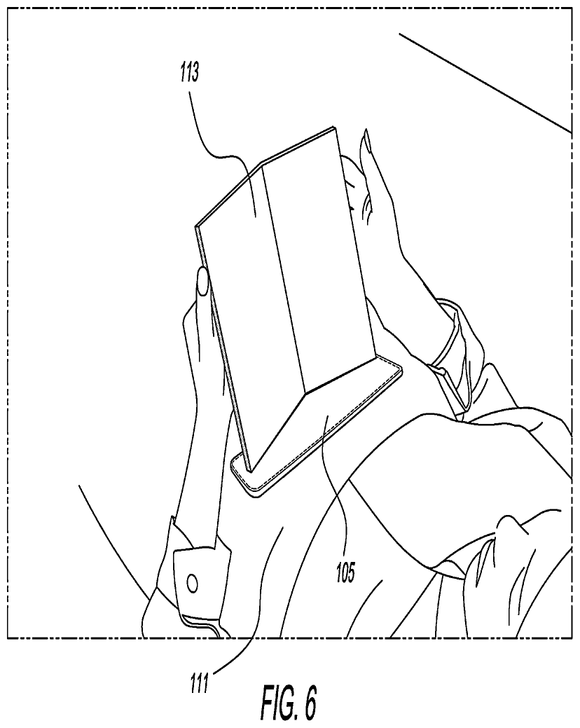

FIG. 6 shows the platform 105 in use with a book 113. The principles illustrated in FIG. 6 will apply to other similar print media. The platform is placed on top of the user's blanket 111 and under the user's book 113. When used in this manner, the platform distributes the weight of the user's hands and book, reducing discomfort. The platform also locates the bottom edge of the book above the blanket, preventing the blanket from interfering with page turning.

What is claimed is:

1. A cushioning platform for use with print media and electronic devices comprising:
a semi-rigid, skin-friendly planar body having friction-enhancing top and bottom surfaces.

2. A cushioning platform for use with print media and electronic devices comprising:
a semi-rigid top member with a friction-enhancing top surface; and
a cushioning bottom member with a skin-friendly, friction-enhancing bottom surface.

3. A cushioning platform for use with print media and electronic devices comprising:
a top member with a friction-enhancing top surface;
a thin, semi-rigid stiffening insert disposed between the top and bottom members; and
a cushioning bottom member with a skin-friendly, friction-enhancing bottom surface.

4. The cushioning platform of claim 3, wherein the edges of the top and bottom members are attached by means of continuous stitching with thread.
While the above cushioning platform descriptions contain many specificities, these should not be construed as limitations on the scope, but rather as exemplifications of several embodiments thereof. Many other variations are possible. By way of example and not limitation, a loop intended to hold a writing instrument or device stylus might be added to one edge of the platform, or the bottom surface of the platform may be textured or shaped to aid ventilation. Accordingly, the scope should be determined not by the embodiment(s) illustrated, but by the appended claims and their legal equivalents.
